(19) United States
(12) Patent Application Publication
(10) Pub. No.: US 2024/0236592 A1
(43) Pub. Date: Jul. 11, 2024

(54) METHOD AND DEVICE FOR AUTOMATED HARMONIZATION OF DIGITAL AUDIO SIGNALS

(71) Applicant: TECH & LIFE SOLUTIONS GmbH, Dresden (DE)

(72) Inventors: Martin SPINDLER, Dresden (DE); Matthias LIPPMANN, Dresden (DE); Johannes PECKMANN, Dresden (DE)

(21) Appl. No.: 17/909,093

(22) PCT Filed: Mar. 4, 2021
(86) PCT No.: PCT/EP2021/055479

§ 371 Date: Sep. 2, 2022

(30) Foreign Application Priority Data
Mar. 6, 2020 (EP) 20161492.2

(51) Int. Cl. H04R 25/00; H04R 3/04

(52) U.S. Cl. CPC H04R 25/75; H04R 3/04; H04R 2430/03

(57) ABSTRACT

The invention discloses a method and a device for automated harmonization of digital audio signals with a target frequency, wherein the digital audio signal is pitch-shifted. In one embodiment of the invention the target frequency is the frequency of a tinnitus sound. Therefore, the method according to the invention is usable in the context of tinnitus treatment.

The invention discloses a method and a device for automated harmonization of digital audio signals with a target frequency, wherein the digital audio signal is pitch-shifted. In one embodiment of the invention the target frequency is the frequency of a tinnitus sound. Therefore, the method according to the invention is usable in the context of tinnitus treatment.

Tinnitus is the hearing of sound when no external sound is present. Basically, tinnitus is not a disease but a symptom that results from a number of different underlying causes. Most common cause is noise-induced hearing loss. Further causes include ear infection, diseases of the heart or blood vessels, Ménierè's disease, brain tumors, emotional stress.

Tinnitus sound is often described as ringing, clicking, hiss or roaring, wherein the sound may be soft or loud, low or high pitched, and appear to be coming from one or both ears. It is a widely known phenomenon, since more than 25% of the inhabitants of industrial countries are affected by tinnitus in the course of their lives.

The primary therapy of tinnitus is talk therapy, sound therapy, hearing aids and cognitive behavioral therapy. Cognitive behavioral therapy is a psycho-social intervention with the aim to improve mental health. Right now, there are no effective medication or supplements to treat tinnitus. Furthermore, the above-mentioned therapy forms are more or less means for the patient to learn to manage the tinnitus.

One of the concepts is sound therapy in the form of tinnitus maskers which helps the brain to ignore the specific tinnitus sound. Tinnitus masker terms a range of devices based on the concept to add natural or artificial sound into the environment of a person suffering from tinnitus to mask the tinnitus sound. The generated noise is designed to be a calming, less intrusive sound than the tinnitus. Depending on the loudness of the sound the tinnitus may be fully or partially masked. To achieve this the masking sound has to be louder compared to the tinnitus sound. Accordingly, tinnitus masking helps to reduce awareness of tinnitus sound during listening to the masking sound.

There are different approaches for tinnitus sound therapy. In therapy sessions, a therapist tries to find a sound with a tinnitus suffering person that corresponds to the subjectively heard tinnitus sound of the person. This is done by trial and fail experiments with different sound generating instruments such as singing bowls, instruments and so on. This is very time consuming for the tinnitus suffering person and it is not ensured that a matching sound will be found.

However, U.S. Pat. No. 8,608,638 B3, for example, reveals a procedure in which a first signal with a frequency as close as possible to the frequency of the tinnitus is combined with a second signal with a frequency around a sub-octave of the tinnitus to generate a tinnitus masking sound.

Furthermore, the tinnitus noise can often be assigned to a certain spatial position by the affected person. Based on this, the object of WO 2001/043678 is to generate a signal that masks the tinnitus, wherein the signal for masking is not only tuned to the frequency of the tinnitus, but also to its spatial position.

WO 00/56120 reveals the adjustment of an audio signal according to a masking algorithm that modifies the intensity of selected frequencies of the audio signal.

However, all of the above-mentioned methods use sounds which are created to mask the tinnitus thereby the quality of the created sound, meaning a pleasant and diverse sound experience, is not accounted. This results in a bad long-time acceptance by tinnitus suffering persons. They often stop such sound masking therapies, since they are bored and/or annoyed by the same masking sound all over again.

However, it is believed that sound therapy could help some tinnitus suffering persons to alleviate the tinnitus sound not just during listening to the masking sound but also beyond that. It is suspected that it could be possible to train the brain by sound masking in a manner that tinnitus sound is alleviated for a long-time. But for this, it is necessary to apply sound masking for longer time periods.

Therefore, it is the purpose of the present invention to provide a method to create a masking sound which increases the motivation of listeners to apply sound masking over longer time periods.

Accordingly, the present invention provides a method for automated harmonization of digital audio signals or control data sequences for synthesizing digital audio signals with a target frequency, wherein the digital audio signal or the control data sequence for synthesizing a digital audio signal is pitch-shifted, comprising the steps
providing a target frequency;
providing a digital audio signal or a control data sequence for synthesizing a digital audio signal;
determination of the main frequency components of the digital audio signal by analyzing the digital audio signal or determination of the main frequency components of the control data sequence by analyzing the control data sequence;
summarizing the main frequency components to tone classes;
calculating a frequency ratio to the target frequency for each tone class;
calculating a weighting factor or a significance value for each tone class;
selecting the frequency ratio of the tone class with the highest weighing factor or the highest significance factor;
pitch-shifting of the digital audio signal or the control data sequence for synthesizing a digital audio signal by the selected frequency ratio;
store and/or play and/or export of the pitch-shifted digital audio signal or the pitch-shifted control data sequence for synthesizing a digital audio signal.

Moreover, the present invention provides a device to perform the method according to the invention.

Furthermore, the usage of the method according to the invention in the context of tinnitus treatment is described.

### DETAILED DESCRIPTION

The present invention provides a method for automated harmonization of digital audio signals or control data sequences for synthesizing a digital audio signals with a target frequency, wherein the digital audio signal or the control data sequence for synthesizing a digital audio signal is pitch-shifted.

According to the invention a target frequency is provided. Basically, the target frequency can be any frequency, in a preferred embodiment of the invention the target frequency is a frequency as close as possible to the frequency of the tinnitus sound of a tinnitus suffering person. In a most preferred embodiment of the invention the target frequency is the frequency of the tinnitus sound.

Therefore, in a preferred embodiment, the present invention provides a method for automated harmonization of digital audio signals or control data sequences for synthesizing a digital audio signals with a target frequency which is as close as possible to the frequency of the tinnitus sound of a tinnitus suffering person or which is the frequency of the tinnitus sound of a tinnitus suffering person, wherein the digital audio signal or the control data sequence for synthesizing a digital audio signal is pitch-shifted.

Methods for determining the frequency of a tinnitus sound of a tinnitus suffering person are known to the person skilled in the art. Accordingly, determining the frequency of a tinnitus sound is not in the scope of the present invention.

The target frequency is entered manually or is provided by an external data source. Suitable external data sources could be audiometers or other devices or software with at least one sound generator that are controlled in frequency in a free or discrete manner.

Furthermore, a digital audio signal or a control data sequence for synthesizing a digital audio signal is provided.

Suitable digital audio signals can be for example music pieces, parts of music pieces or sounds.

In a preferred embodiment of the invention the digital audio signal is a compressed or uncompressed audio format file. Basically, any kind of compressed audio format is suitable.

Up to date most common compressed audio format files include .wma, .mp3, .mp4 (AAC), .ogg (Vorbis), and .flac files. Suitable uncompressed format files are for example PCM coded RIFF WAV or LPCM coded AIFF. However, basically any kind of uncompressed audio format is suitable.

In another embodiment of the invention the digital audio signal is provided by an on-demand audio stream service in a compressed or uncompressed data format. An on-demand audio stream service provides digital audio signals which can be downloaded or pulled package-wise into a playback client on-demand. In this way a very large selection of music and sounds is made available.

Furthermore, a control data sequence for synthesizing a digital audio signal can be provided. The digital audio signal which is synthesized by the control data sequence can be for example music pieces, parts of music pieces or sounds. Such control data sequences can be available locally or they can be made available on-demand. Control data sequences are preferably standard MIDI files (SMF), but may also be, for example, in MusicXML, Karaoke-MIDI, or some Tracker Format (MID, XM, IT).

In a preferred embodiment the digital audio signal or the control data sequence for synthesizing a digital audio signal is personally chosen by a tinnitus suffering person. Thus, the kind of digital audio signal or control data sequence for synthesizing a digital audio signal just depends on the individual music taste of the tinnitus suffering person and the person is free to choose his or her favorite music pieces. A requirement when choosing pieces of music is, however, that they must have a harmonious character, so they may not be purely percussive.

According to the invention the main frequency components of the digital audio signal are determined by analyzing the digital audio signal or by analyzing the control data sequence.

If a digital audio signal is provided, the main frequency components of the digital audio signal are determined by analyzing the digital audio signal. Basically, tones occurring in any audio signal are characterized by its magnitude and its frequency. According to the invention the main frequency components are defined as those frequency components having the highest magnitudes in the whole audio signal, comprising the frequency component with the highest magnitude, the frequency component with the second highest magnitude, the frequency component with the third highest magnitude and so on.

In one embodiment the frequency components with the 10 to 100 highest magnitudes determine the main frequency components, preferably the frequency components with the 40 to 80 highest magnitudes determine the main frequency components, more preferably the frequency components with the 50 highest magnitudes determine the main frequency components.

In one embodiment of the invention the main frequency components are determined by analyzing the frequency spectrum of the digital audio signal. Therefore, the time signal of the digital audio signal is divided in time windows, wherein a von-Hann-window function is applied to each time window. In one embodiment of the invention neighboring time windows are overlapping with each other. Thereby, neighboring time windows are overlapping with each other in a range of 0 to 90%, preferably in a range of 20% to 70%, most preferably the time windows are overlapping 50% with each other.

In one embodiment of the invention the time windows have a length in the range of 92.88 ms to 1.486.08 ms (4096 to 65.536 samples at 44100 Hz sample rate), preferably large windows are used for best frequency resolution.

Furthermore, the time windows can have but not have to have a constant length. According to the invention at least 70% of the time signal of the digital audio signal is divided into time windows, preferably 80% of the time signal of the digital audio signal is divided into time windows, more preferably 90% of the time signal of the digital audio signal is divided into time windows, most preferably 100% of the time signal of the digital audio signal is divided into time windows.

For each time frame a frequency spectrum is calculated, methods e.g. like Fast-Fourier Transformation (FFT), which are suitable to transfer a time signal into the frequency space are well known in the art. All frequency spectra are accumulated to one main spectrum which represents the frequency components of the analyzed digital audio signal with its magnitudes.

In one preferred embodiment of the invention 100% of the digital audio signal is divided into time frames and analyzed. Accordingly, the main spectrum represents all frequency components of the digital audio signal.

In one embodiment of the invention the main frequency spectrum is calculated from the whole time signal of the digital audio signal without dividing the time signal into time windows.

In one embodiment of the invention frequency components in the main spectrum which are separated by less than 10 cents, preferably less than 8 cents, most preferably less than 5 cents are combined to one frequency peak at a center frequency, wherein their magnitudes are accumulated. The center frequency is the frequency of the frequency component with the highest magnitude before combining the single frequency components.

Cent is the unit of a music interval. In music theory a music interval is the difference in pitch between two tones and expresses their frequency ratio. One cent is a hundredth of a semitone interval. One semitone is a twelfth of an octave. One octave is a frequency difference ratio of 2.0, or one octave down is a frequency ratio of 0.5. In western culture the smallest music interval is a semitone, therefore using the common division in octaves a music interval can be determined by a frequency ratio in the following way: music Interval=1200 cent*log₂(f₂/f₁).

From the main spectrum the main frequency components are determined by sorting the frequency components in the main spectrum by the height of their magnitude. The frequency components in the main spectrum with the highest magnitudes determine the main frequency components. In a preferred embodiment of the invention the frequency components with the 50 highest magnitudes determine the main frequency components.

If a control data sequence for synthesizing a digital audio signal is provided, the main frequency components are determined by analyzing the control data sequence. Therefore, a histogram of the frequencies occurring in the digital audio signal over time is created. Those frequencies are the fundamental frequencies to be generated for the tones in the synthesizer's standard tuning. The histogram illustrates the frequency components of the synthesized digital audio signal. Means for analyzing a control data sequence for synthetic sound generation to obtain such a histogram are well known in the art. From the histogram the main frequency components are determined by sorting the frequency components in the histogram according to the duration of their appearance. Thus, the durations each time a frequency component appears in the synthesized digital audio signal is accumulated to a summation value Tₛᵤₘ. Accordingly, the frequency components which have the greatest values Tₛᵤₘ determine the main frequency components. In a preferred embodiment of the invention the frequency components with the 50 greatest values Tₛᵤₘ determine the main frequency components.

In a preferred embodiment of the invention the main frequency components of the digital audio signal or the control data sequence for synthesizing a digital audio signal are temporarily or permanently stored.

Furthermore, according to the invention the main frequency components are summarized in tone classes.

In one embodiment of the invention, the frequency components are summarized in tone classes wherein all tones with an interval of one octave (e.g. C, c, c′, c″, . . . ) build one tone class. Which means tone classes are formed from octave-multiple frequencies.

In a further embodiment of the invention, the frequency components are summarized to tone classes of a fundamental frequency and its natural harmonic overtone frequencies. Which means tone classes are formed from multiple frequencies (overtones) of a fundamental frequency.

In one embodiment of the invention the 10 to 100 main frequency components of the digital audio signal or the control data sequence are summarized in tone classes, preferably the 40 to 80 main frequency components are summarized in tone classes, most preferably the 50 main frequency components are summarized in tone classes.

According to the invention the frequency ratio d of at least one of the tone classes to the target frequency is calculated. In a preferred embodiment the frequency ratio d of all tone classes is calculated.

The frequency ratio d is calculated by the following formula:

$$d = 1200 cent \cdot {log}_{2} ( {f}_{class} / {f}_{target} ) , \qquad ( 1 )$$

wherein the frequency ratio d is determined as music interval in cent. The frequency ratio represents a geometric ratio of the frequencies.

According to the invention the calculated frequency ratio d of the tone classes to the target frequency is temporarily or permanently stored.

Furthermore, a weighting factor or a significance value is calculated for each tone class. According to the invention a weighting factor is calculated if a digital audio signal is provided and a significance value is calculated if a control data sequence is provided.

Thus, in one embodiment of the invention a weighting factor is calculated as described in the following.

Firstly, a harmonic strength is determined for each tone class. This is done by accumulating the magnitudes of all main frequency components belonging to one tone class.

Afterwards, in one embodiment the weighting factor w is calculated for each tone class using the following formula:

$$w = ( {harmonicStrength}_{class} ) / ( {log}_{2} ( {f}_{class} / {f}_{target} ) ) . \qquad ( 2 a )$$

In another embodiment of the invention the weighting factor w is calculated for each tone class using the following formula:

$${w}_{class} = \sqrt{{( {normedHarmonicStrength}_{class} )}^{2} + {( {normalizedDistanceRating}_{class} )}^{2}} \qquad ( 2 b )$$

$$where$$

$${normedHarmonicStrength}_{class} = \frac{{harmonicStrength}_{class}}{{harmonicStrength}_{m ax}}$$

$$and$$

$${normalizedDistanceRating}_{class} = \frac{Φ ( - \frac{\vert d \vert}{150} + 2 ) - Φ ( - 2 )}{Φ ( 2 ) - Φ ( - 2 )}$$

$$and$$

$$Φ ( x ) = \frac{1}{2} ( 1 + erf ( \frac{x}{\sqrt{2}} ) )$$

$$and$$

$$d = 1200 cent \cdot {log}_{2} ( {f}_{class} / {f}_{target} )$$

In a preferred embodiment of the invention the weighting factor w is calculated for each tone class using the following formula:

$${w}_{class} = \sqrt{{( 1 , 0 \cdot {normedHarmonicStrength}_{class} )}^{2} + {( 0 , 8 \cdot normedProximity )}^{2}} \qquad ( 2 c )$$

$$where$$

$${normedHarmonicStrength}_{class} = \frac{{harmonicStrength}_{class}}{{harmonicStrength}_{m ax}}$$

$$and$$

$${normedProximity}_{class} = \vert 1 - ( 2 \cdot ( {log}_{2} ( \frac{{f}_{class}}{{f}_{target}} ) ) mod 1 , 0 ) \vert$$

Wherein harmonicStrengthₘₐₓ is the maximum harmonic strength of all considered tone classes and wherein f_{class} is a frequency representing the tone class and is defined as frequency included in the tone class which is closest to the target frequency. f_{target} is the target frequency according to the invention.

If a control data sequence for synthesizing a digital audio signal is provided a significance value is calculated. Therefore, Tₛᵤₘ of every frequency component belonging to one tone class are accumulated to a value T_{class}. The significance value is defined by sorting the tone classes by their T_{class} values. The tone class with the highest T_{class} is given the highest significance value, the tone class with the second highest T_{class} is given the second highest significance value, the tone class with the third highest T_{class} is given the third highest significance value and so on.

In one embodiment of the invention the calculated weighting factors and/or the calculated significance values are temporarily or permanently stored.

According to the invention the frequency ratio of the tone class with the highest weighting factor or the highest significance value is selected. Thus, the tone class with the highest weighting factor or the highest significance value will be selected as the one to match the target frequency after pitch shifting.

The calculated frequency ratio d defines the input parameter d′ for the pitch-shifting algorithm as follows:

$${d}^{′} = - d , \qquad ( 3 )$$

and thus defines the amount of the relative change in pitch.

According to the invention the digital audio signal or the control data sequence for synthesizing a digital audio signal is pitch-shifted by the selected frequency ratio.

In one embodiment of the invention the whole digital audio signal or the whole control data sequence for synthesizing a digital audio signal is pitch-shifted by the calculated frequency difference. Pitch-shifting is a sound recording technique in which the original pitch of a sound is raised or lowered without altering the tempo or playtime length of the music. Pitch-shifting can be done by an effect unit called pitch-shifter that raise or lower the pitch by a pre-designated amount, therefore pitch-shifter utilize pitch-shifting algorithms. The mode of operation of pitch-shifters is well known to the person skilled in the art. In many approaches time-scaling methods are applied, followed by resampling conversion to accomplish pitch-shifting. An overview of time-scaling methods is given by Driedger et al. Suitable devices for performing pitch-shifting algorithms are for example phase vocoders.

In another embodiment of the invention pitch-shifting is done by adjusting the control data of a control data sequence for a synthetic sound generation device. In a further embodiment of the invention pitch-shifting is done by adjusting the tuning of a synthetic sound generation device. The mode of operation in these cases is well known to the person skilled in the art.

According to the invention the pitch-shifted digital audio signal or the control data sequence for synthesizing a digital audio signal is stored and/or played and/or exported.

In one embodiment of the invention a maximum pitch difference or a maximum shift frequency ratio is provided. The maximum pitch difference describes a maximum value by which the digital audio signal or the control data sequence is pitch-shifted. The maximum pitch difference is given as music interval and is preferably between −400 cent and +400 cent and more preferably between −300 cent and +300 cent. This maximum pitch difference is convertible to a maximum shift frequency ratio using the following formula (an inversion of formula 1):

$$maximum shift frequency ratio = 2 ( \frac{maximum pitch difference}{1200} ) \qquad ( 4 )$$

If a maximum pitch difference is provided, a maximum shift frequency ratio is calculated using formula (4). According to the invention in this embodiment the selected frequency ratio d is compared with the maximum shift frequency ratio and if the selected frequency difference d is higher than the maximum shift frequency ratio, the frequency ratio d of the tone class with the next highest weighting factor or the next highest significance value is compared with the maximum shift frequency ratio. This is done until the frequency ratio d of the tone class is equal or smaller compared to the maximum shift frequency ratio, wherein the frequency ratio d which has the highest weighting factor or the highest significance value and which is equal or smaller compared to the maximum shift frequency ratio is used for pitch-shifting the digital audio signal or the control data sequence for synthesizing a digital audio signal.

Accordingly, the frequency ratios d of the tone classes are compared with the maximum shift frequency ratio. Starting with the tone class with the highest weighting factor or the highest significance value, if the above-mentioned condition is not fulfilled the frequency ratio d of the tone class with the second highest weighting factor or the second highest significance value is calculated and compared with the maximum shift frequency ratio. If the above-mentioned condition is again not fulfilled, the frequency ratio d of the tone class with the next highest weighting factor or the next highest significance value is calculated and compared and so on.

Until a tone class of the digital audio signal is found, for which the frequency ratio d is equal or smaller compared to the maximum shift frequency ratio. This frequency ratio d is used to pitch-shift the digital audio signal or the control data sequence for synthesizing a digital audio signal.

Since the weighting factor w or the significance value is limiting the selected frequency distance, the pitch-shifted digital audio signal obtained by the method according to the invention provides such a high sound quality that the listening experience is not limited compared to the listening experience of the original digital audio signal or the digital audio signal which is synthesized by the original control data sequence.

The invention additionally provides a device for performing the method according to the invention, characterized in that the device comprises:
A data processing device;
A data storage device;
At least one input interface;
At least one output interface;
Optionally a device for sound synthesis;
Optionally loudspeakers and/or headphones.

All features described for the method also apply for the device according to the invention and vice versa. Therefore, a detailed description of the device is omitted and reference is made to the description of the method.

However, the device according to the invention comprises a data processing device. Suitable data processing device are PC, smartphones, tablets and so on. The data processing device should have interfaces to be connectable to other data processing devices to receive and send data. Such interfaces could be for example USB and/or Bluetooth and/or interfaces to provide access to the internet, wherein access to the internet can be provided wired and/or wireless.

Moreover, the device comprises a data storage, suitable to store the digital audio signal and/or the frequency components of the digital audio signal and/or the frequency difference d of the tone class to the target frequency and/or the pitch-shifted digital audio signal.

In a further embodiment of the invention the main frequency components are determined as described above by an external device and provided to be used by the device and the method according to the invention.

The device according to the invention comprises at least one input interface. In one embodiment of the invention the device comprises an input interface for audio data in form of digital audio stream or digital audio files. In another embodiment the device according to the invention comprises an interface for control data or control data sequences for synthetic sound generation. In a further embodiment of the invention the device comprises an input interface for audio data in form of digital audio stream or digital audio files and an interface for control data or control data sequences for synthetic sound generation.

Furthermore, the device comprises at least one output interface. In one embodiment of the invention the device comprises an output interface for audio data in form of digital audio stream or digital audio files. In another embodiment of the invention the device comprises an output interface for control data after adjusting pitch, either as live data or file. In a further embodiment of the invention the device according to the invention comprises an output interface for audio data in form of digital audio stream or digital audio files and an output interface for control data after adjusting pitch, either as live data or file.

If the digital audio signal is a compressed or uncompressed audio format file, the pitch-shifted digital audio signal can be audible via loudspeakers or headphones according to the invention. Therefore, the device according to the invention comprises in one embodiment loudspeakers and/or headphones.

If the digital audio signal is a control data sequence for synthetic sound generation, the pitch-shifted digital audio signal can be audible via a sound synthesis. According to the invention sound synthesis can be done internal, by the device according to the invention or external by an additional device for sound synthesis. Therefore, the device according to the invention comprises in one embodiment a device for sound synthesis.

Furthermore, the usage of the method and the device is described, characterized in that the method and the device are used in the context of tinnitus treatment. Therefore, the tinnitus frequency of a tinnitus suffering person or a frequency as close as possible to the frequency of the tinnitus sound of a tinnitus suffering person is used as target frequency.

Especially in the context of tinnitus treatment the method and the device according to the invention has several advantageous over the state of the art. First of all the pitch-shifted digital audio signal or pitch-shifted control data sequences for synthesizing digital audio signals obtained by the method according to the invention provides such a high sound quality that the listening experience is not limited compared to the listening experience of the original digital audio signal or the digital audio signal synthesized by the original control data sequence. Secondly, the pitch-shifted digital audio signal or the pitch-shifted control data sequence contains a certain target frequency. If the target frequency is equivalent or almost equivalent to the frequency of the tinnitus sound of a tinnitus suffering person, the pitch-shifted digital audio signal or the pitch-shifted control data sequence is suited as tinnitus masking sound. The combination of these properties implies that the pitch-shifted audio signal or the pitch-shifted control data sequence is particularly suitable for the long-term treatment of tinnitus.

Furthermore, since the digital audio signal or the control data sequence for synthesizing a digital audio signal can be freely chosen by the tinnitus suffering person just depending on its individual music preferences and its mood, motivation is even increased since favorite music or sounds can be used. The method is applied in such a fast and easy way, that different digital audio signals or different control data sequences for synthesizing digital audio signals can be used in the method and thereby a user can fast create a repertoire of pitch-shifted audio signal or pitch-shifted control data sequence which he can use as tinnitus masking sounds. It is no longer necessary that the user has to listen to just one masking sound during tinnitus treatment.

In addition to this, the method according to the invention provides a masking sound which is harmonized to the tinnitus sound of the tinnitus suffering person and which therefor masks the tinnitus sound. Advantageously, it is not to use high volume levels as it is often done by the state of the art methods, which increases the motivation to use the harmonized digital audio signal as masking sound.

Moreover, harmonization of a digital audio signal or a control data sequence for synthesizing a digital audio signal with a target frequency according to the invention is also useful for musicians.

Basically music pieces are written for particular instruments and the pitches of these particular instruments. Therefore, musicians are limited in the choice of the instrument with which to play a music piece. However, sometimes musicians want to play a music piece with another, originally not suited instrument. According to the invention a certain piece of music can serve as digital audio signal which is harmonized to a target frequency, wherein the target frequency is determined by an instrument with which the musician wants to play the music piece. This increases the freedom in the choice of instrument with witch to play a certain music piece.

Furthermore, not every instrument is well-tuned. In such cases it is not possible for a musician to play along for example with a concert recording. According to the invention a concert recording can serve as digital audio signal which is harmonized with the frequency of the instrument out of tune.

In the following the invention is further described by 8 figures and 2 examples.

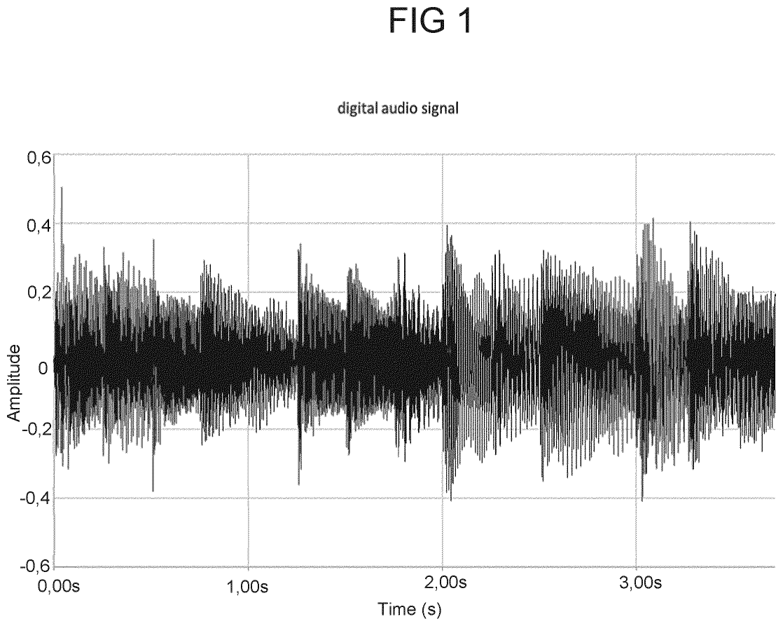

FIG. 1 shows a time signal of a digital audio signal;

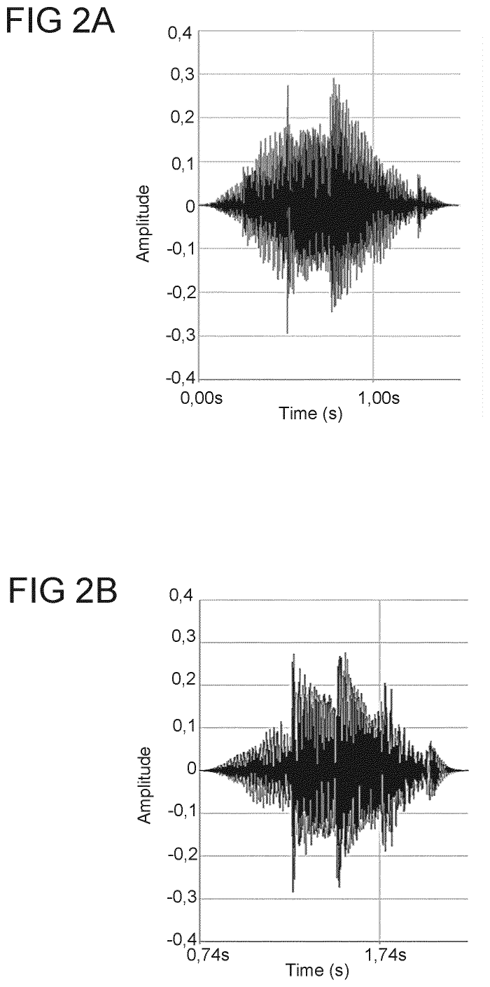

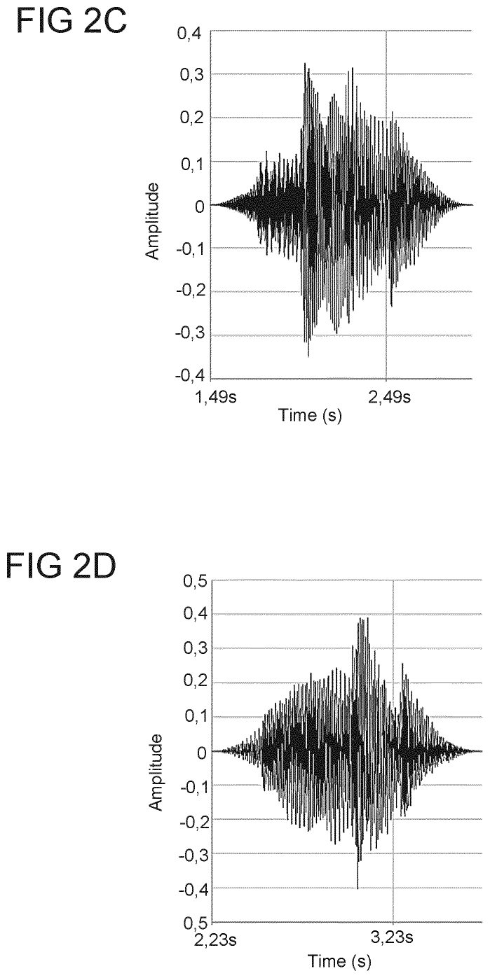

FIG. 2 shows four overlapping time windows (a) to (d) of the time signal of the digital audio signal of FIG. 1, wherein each time window was generated by applying a von-Hann-window function;

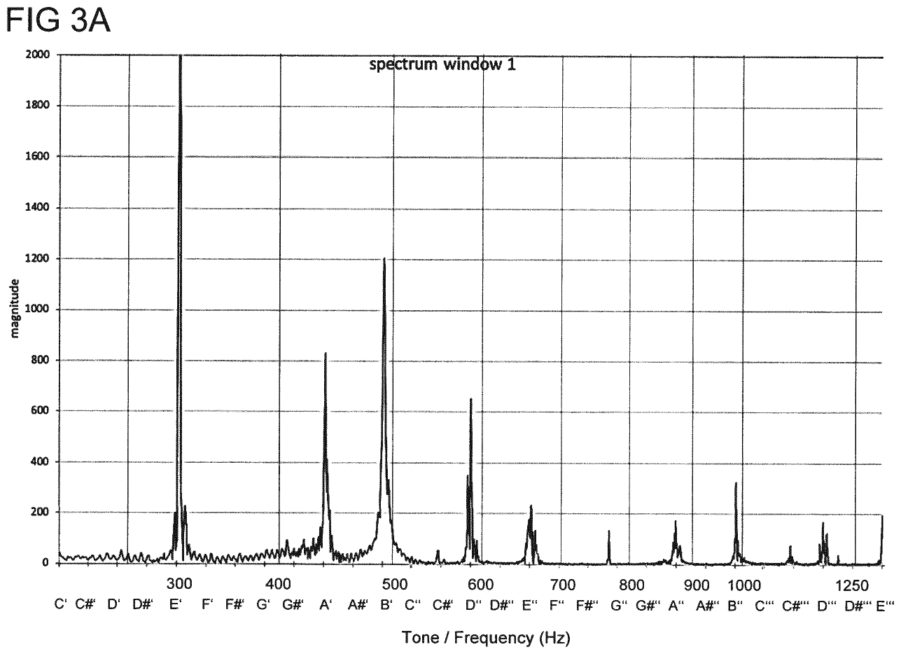

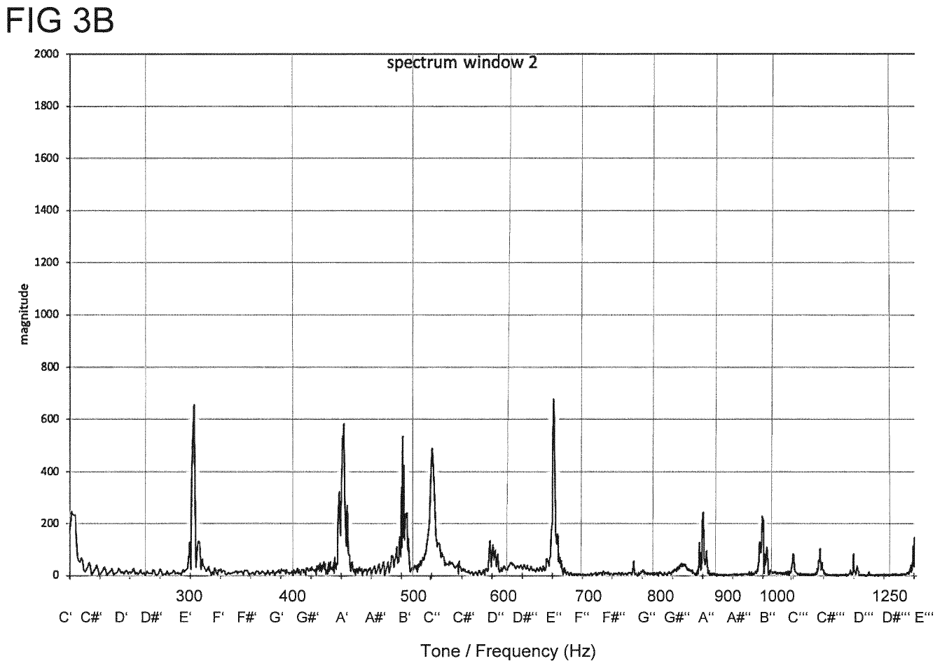

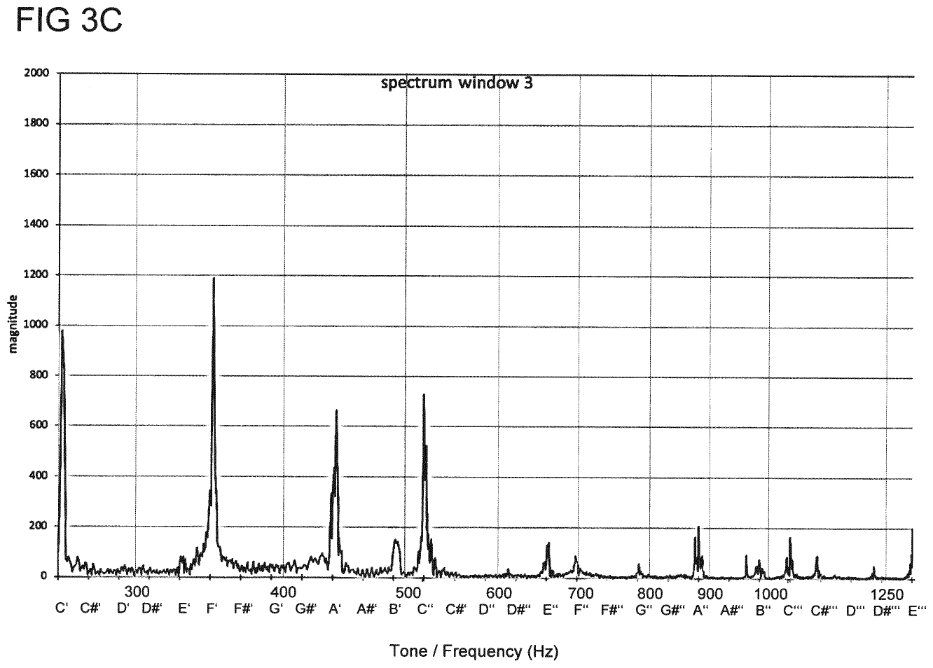

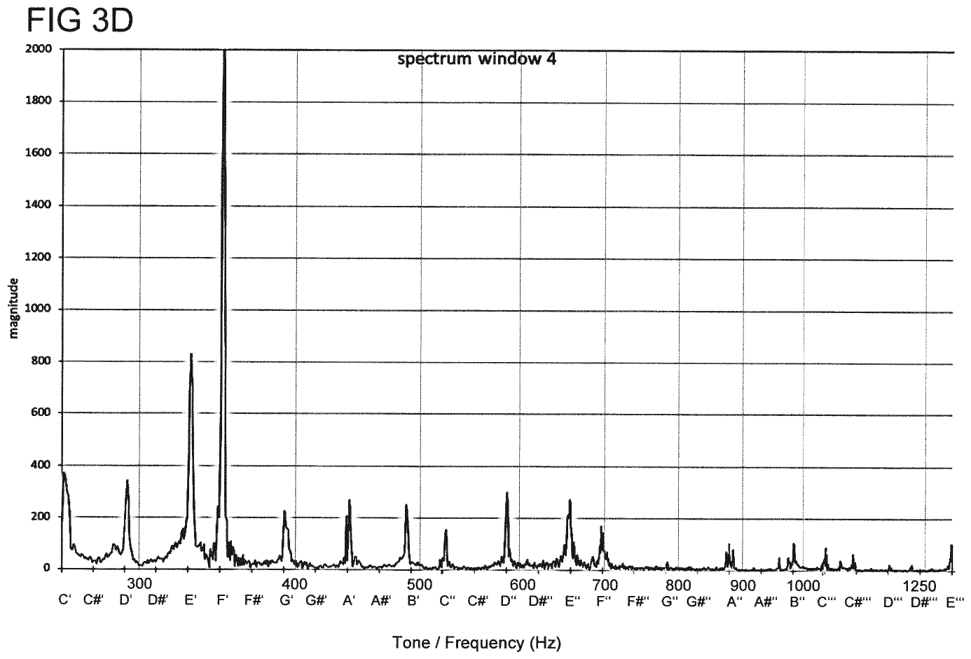

FIG. 3 (a) to (d) show the frequency spectrum for each of the time windows shown in FIG. 2 (a) to (d);

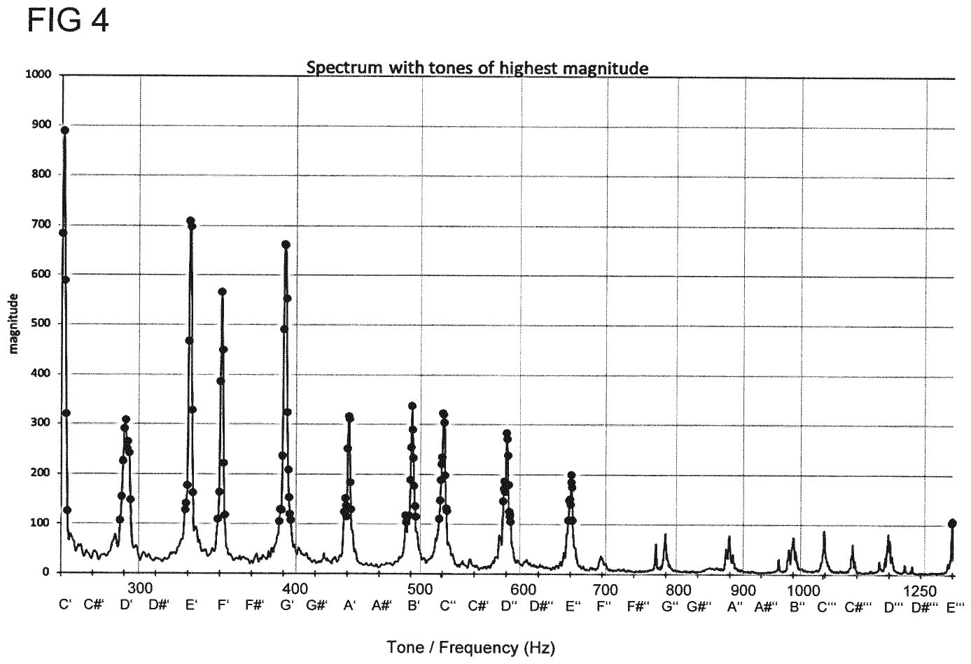

FIG. 4 shows the accumulated spectrum of spectra (a) to (d) of FIG. 3 and all other overlapping time windows from the overall digital audio signal of FIG. 1;

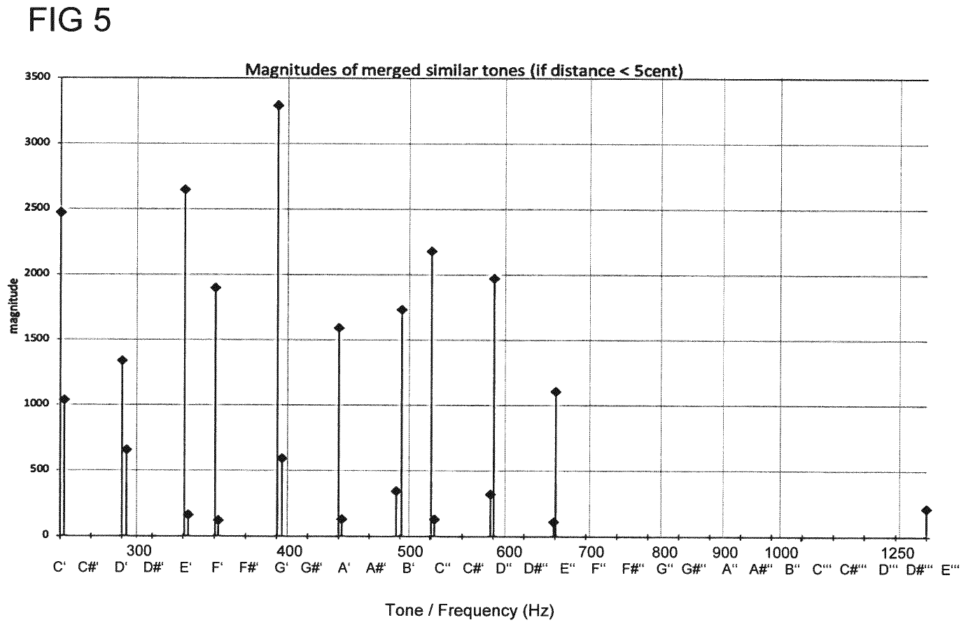

FIG. 5 shows the accumulated spectrum of FIG. 4, wherein all frequencies with a frequency distance below 5 cent are accumulated;

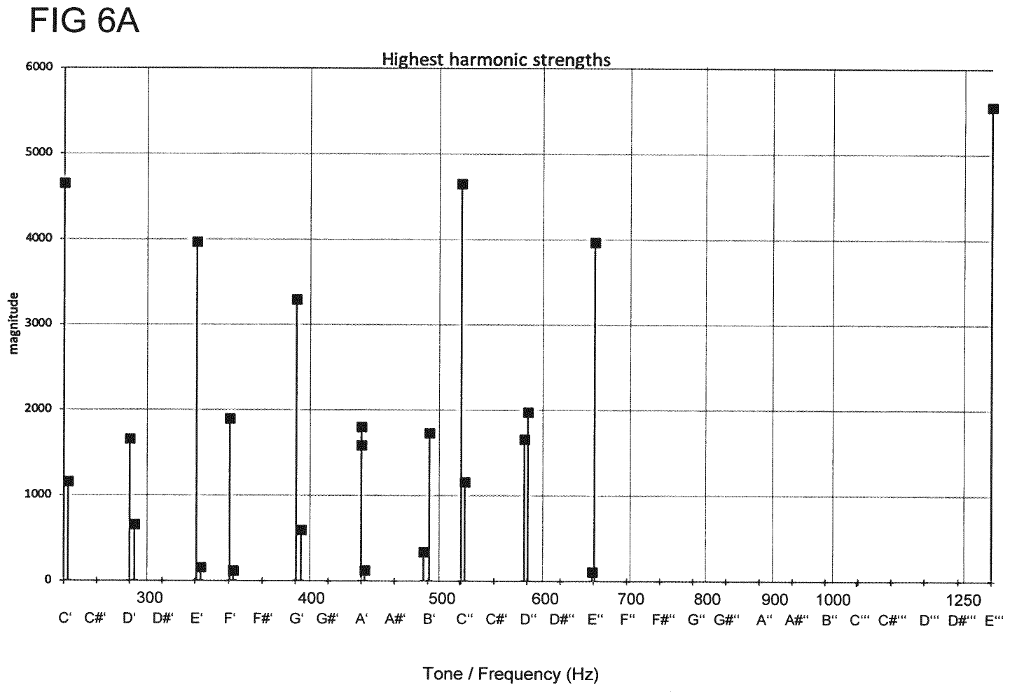

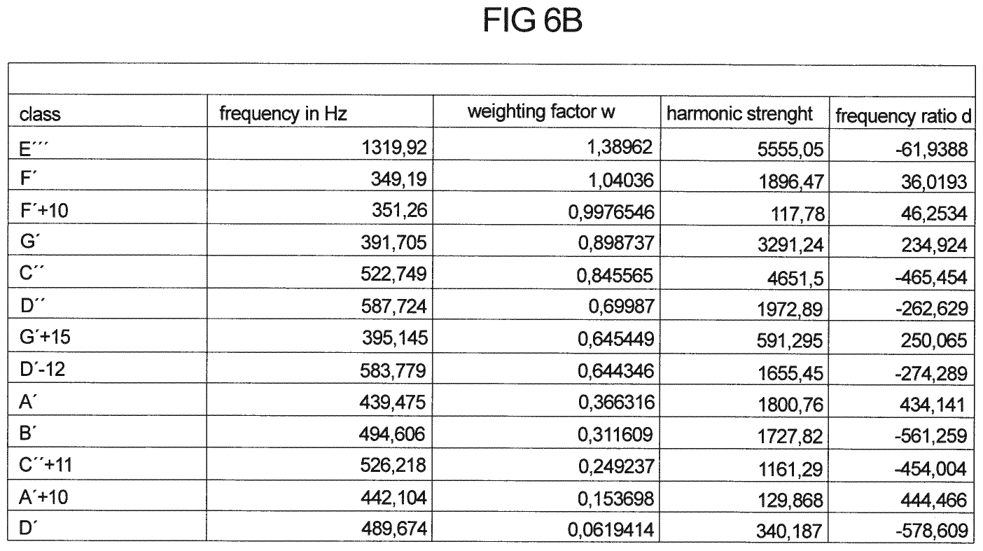

FIG. 6 (a) shows the frequency components of the digital audio signal summarized in tone classes and (b) shows a table of the tone classes and the corresponding weighting factors;

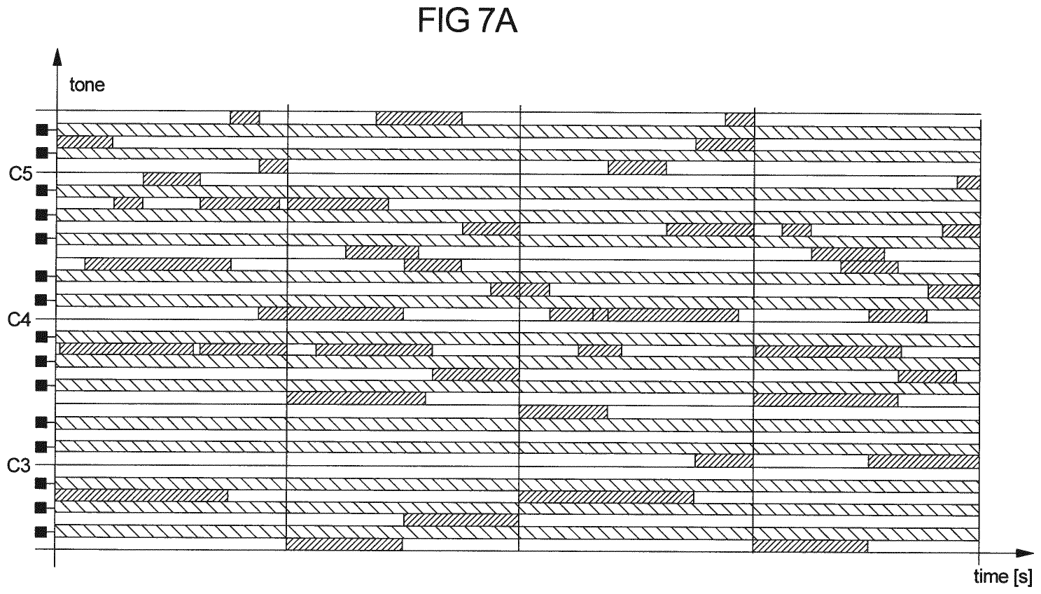

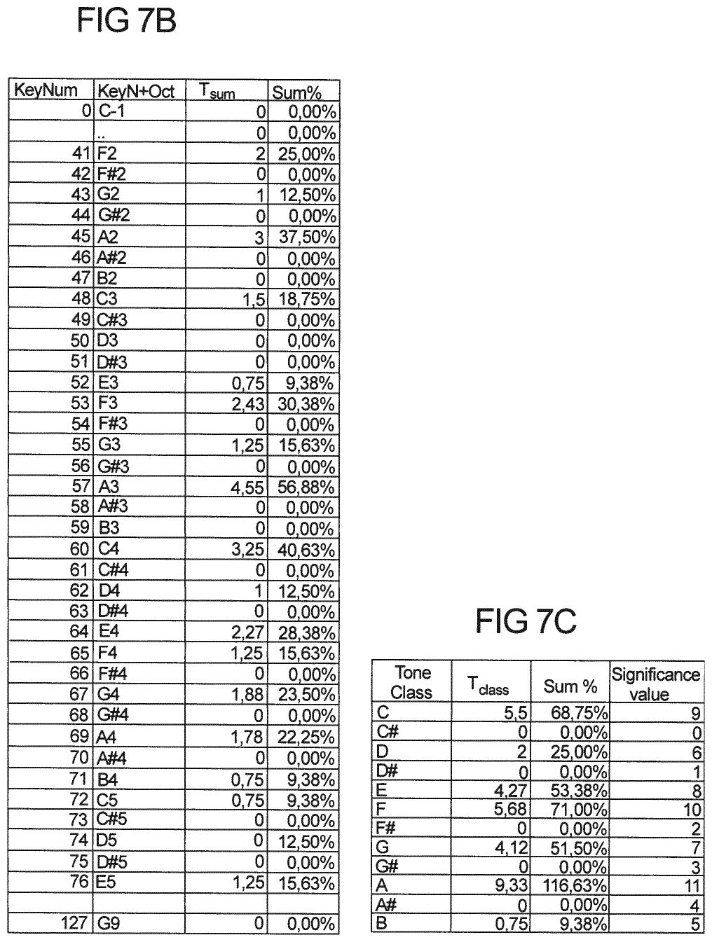

FIG. 7 (a) illustrates a control data sequence for synthesizing a digital audio signal, (b) is a histogram table of the frequency components with the summed duration of their appearance Tₛᵤₘ and (c) illustrates summarized tone classes of the histogram and their significance values;

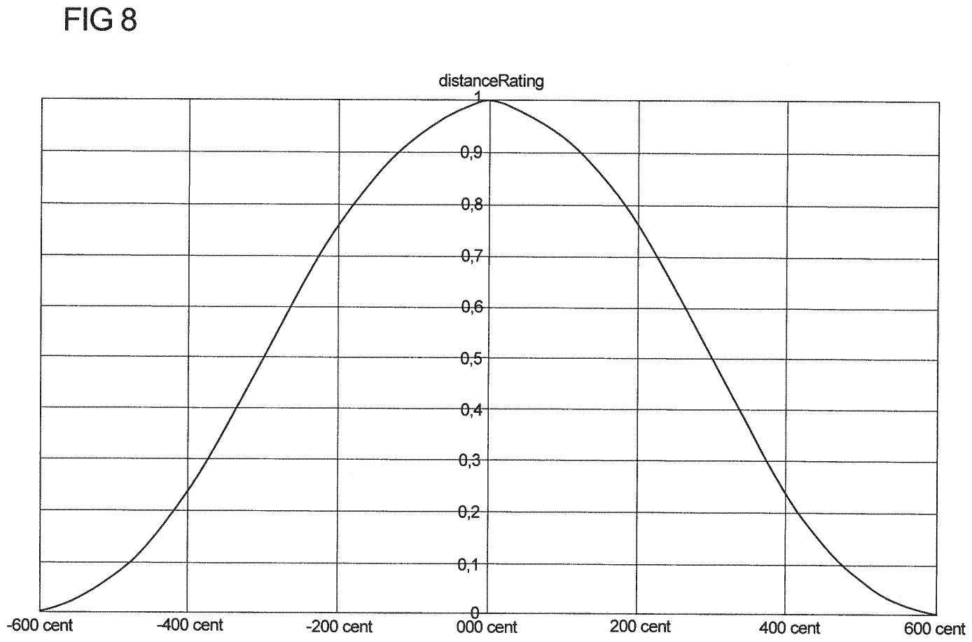

FIG. 8 illustrates a weighting curve for the calculation of the normalizedDistanceRating of a tone class as used in formula 2b.

FIG. 1 shows an exemplary time signal of a digital audio signal, which is provided according to the invention.

In FIG. 2 (a) to (d) show four overlapping time windows of the time signal of the digital audio signal of FIG. 1, wherein each time window overlaps to 50% with the next adjacent time window and wherein a von-Hann-window function was applied to each window.

FIG. 3 (a) to (d) illustrate the main frequency spectra calculated from the time windows of FIG. 2 (a) to (d). The main frequency components of the time windows are shown in dependence of their magnitude.

According to the invention the spectra of the time windows are accumulated, resulting in a main spectrum showing the main frequency components of all time windows in dependence of their accumulated magnitude as shown in FIG. 4. Furthermore, in FIG. 4 the tones with the highest magnitudes are marked by points.

The frequency components in the main spectrum which are separated by less than 5 cents are combined to one frequency peak at a center frequency, wherein their magnitudes are accumulated. The center frequency is the frequency of the frequency component with the highest magnitude before combining the single frequency components. FIG. 5 shows the spectrum of the frequency components after combining all frequency peaks which are separated by less than 5 cent. The 20 marked frequency components illustrate the main frequency components of the digital audio signal.

According to the invention, the main frequency components are summarized into tone classes. Thereby, the harmonic strength is determined for every tone class. This is done by accumulating the magnitudes of all main frequency components belonging to one tone class. FIG. 6 (a) illustrates the tone classes in dependence of the harmonic strength for the frequency peaks shown in FIG. 5.

Thereafter, the tone classes can be weighted according to the invention. A weighting factor is calculated for every tone class. A table showing the weighting factor for 13 of the tone classes shown in FIG. 6 (a) is shown in FIG. 6 (b).

In a further embodiment of the invention a control data sequence for synthesizing a digital audio signal is provided. According to the invention a histogram of the frequencies occurring in the digital audio signal over time is created. Those frequencies are the fundamental frequencies to be generated for the tones in the synthesizer's standard tuning. The histogram illustrates the frequency components of the digital audio signal which can be synthesized by the control data sequence. Means for analyzing a control data sequence for synthetic sound generation to obtain such a histogram are well known in the art. Such a control data sequence is illustrated in FIG. 7 (a). The piano roll diagram illustrates the tones (y-axis) occurring in the control data sequence and the timescale (x-axis) in which they occur.

Furthermore, the times for which each frequency component appears in the control data sequence are accumulated into a histogram giving the value Tₛᵤₘ which is shown in the table in FIG. 7 (b). The frequency components which have the highest Tₛᵤₘ determine the main frequency components. Those main frequency components are summarized in tone classes according to the invention. The table of FIG. 7 (c) shows the tone classes built for the main frequency components of the table of FIG. 7 (b) and their significance value.

FIG. 8 illustrates a weighting curve according to the invention, used for the calculation of the normalizedDistanceRating of a tone class in formula 2b.

### Example 1

A target frequency of 2735.66 Hz was known from a tinnitus suffering person. A digital audio signal was provided as .mp3 file with a total length of 16 s. The whole time signal of the digital audio signal was divided into 21 time frames, each with a length of 1,486 s. For each time frame a spectrum was calculated by FFT. The 21 spectra were accumulated to one main spectrum.

Frequency components which were separated by less than 5 cents were added to one frequency component at a center frequency. The center frequency was chosen as the frequency of the frequency component with the highest magnitude before combining the single frequency components. Thereafter, the 50 main frequency components were determined as the frequency components in the main spectrum with the 50 highest magnitudes. The main frequency components were temporarily stored.

All 50 main frequency components were sorted into tone classes. Thereby, 13 tone classes have resulted. The magnitudes of every frequency component belonging to one tone class were accumulated and the resulting magnitude determined the harmonic strength of the tone class. Thereafter, every tone class was weighted calculating the weighting factor w according to formula (2b). Tone class E′″ (with fundamental frequency of 1319.92 Hz) was the tone class with the highest weighting factor w=1,39. The weighting factor was calculated using formula 2b).

The frequency difference d was calculated for this tone class using formula (3) d=−62 cent. d′=−d was used as input parameter for a pitch-shifting algorithm and the whole digital audio signal was pitch shifted by 62 cent.

### Example 2

A target frequency of 2735.66 Hz was known from a tinnitus suffering person. A control data sequence was provided as .mid file with a total length of 8 s. MIDI defines different 128 keys in halftone steps. For every possible key, the duration of each note with that key contained in the sequence was summed up. For example, A3 is to be played in total for 4.55 seconds. Keys of the same tone class (octave multiples) are then summarized into 12 tone classes, so class A is to be played in total 9.33 s for example. The class with the highest significance is selected. For every key in the class, the Frequency in the synthesizers base tuning is calculated. The formula for getting a frequency of a key Number applying a base tuning A′=440 Hz is: f_{keyNum}=440.0 Hz*2\hat{ }^{((keyNum-69)/12)}. So e.g. for A: {27.50 Hz, 55.00 Hz, 110.00 Hz, 220.00 Hz, 440.00 Hz, 880.00 Hz, 1760.00 Hz, 3520.00 Hz, 7040.00 and 14080.00 Hz}. The nearest distance ratio of one of the classes frequencies is selected as distance to the target (tinnitus) frequency, e.g. for A″″=3520.00 Hz, d=426 cent. So a pitch shifting of d′=−426 is to be applied.

The maximum distance allowed might be limited to avoid particularly large pitch shifting. In that case the class with next best significance would be selected. However, in most cases, the quality difference due to changing the pitch when using a synthesizer would not be so noticeable as for changing digital audio.

### REFERENCES

Driedger, J., Müller, M., A Review of Time-Scale Modification of Music Signals, Appl. Sci. 6, 57, 2016

1. A method for automated harmonization of digital audio signals or control data sequences for synthesizing digital audio signals with a target frequency, wherein the digital audio signal or the control data sequence for synthesizing digital audio signal is pitch-shifted, comprising the steps
providing a target frequency;
providing a digital audio signal or a control data sequence for synthesizing a digital audio sign;
determining the main frequency components of the digital audio signal by analyzing the digital audio signal or determining the main frequency components of a control data sequence by analyzing the control data sequence;
summarizing the main frequency components to tone classes;
calculating a frequency ratio to the target frequency for each tone class;
calculating a weighting factor or a significance value for each tone class;
selecting the frequency ratio of the tone class with the highest weighing factor or the highest significance factor;
pitch-shifting of the digital audio signal or the control data sequence for synthesizing a digital audio signal by the selected frequency ratio;
store and/or play and/or export of the pitch-shifted digital audio signal or the pitch-shifted control data sequence for synthesizing a digital audio signal.

2. The method according to claim 1, characterized m that the method comprises additionally the steps of
providing a maximum shift frequency ratio;
comparing the selected frequency ratio with the maximum shift frequency ratio and if the selected frequency ratio is higher than the maximum shift frequency ratio, the selected frequency ratio d of the tone class with the next highest weighting factor or the next highest significance value is compared with the maximum shift frequency ratio until the selected frequency ratio of the tone class is equal or smaller compared to the maximum shift frequency ratio, wherein the selected frequency ratio which has the highest weighting factor or the highest significance value and which is equal or smaller compared to the maximum shift frequency is used for pitch-shifting the digital audio signal or the control data sequence for synthesizing a digital audio signal.

3. The method according to claim 1, characterized in that the target frequency is entered manually or is provided by an external data source.

4. The method according to claim 1, characterized in that the digital audio signal is a compressed or uncompressed audio format file.

5. The method according to claim 1, characterized in that the digital audio signal is provided by an on-demand audio stream service.

6. The method according to claim 1, characterized in that the digital audio signal is generated by providing a local or on-demand control data sequence for synthetic sound generation.

7. The method according to claim 1, characterized in that determination of the main frequency components of the digital audio signal or the control data sequence for synthesizing a digital audio signal is done by analyzing the control data sequence for synthesizing a digital audio signal or by analyzing the frequency spectrum of a digital audio signal.

8. The method according to claim 1, characterized in that the main frequency components of the digital audio signal or the control data sequence for synthesizing a digital audio signal are temporarily or permanently stored.

9. The method according to claim 1, characterized in that pitch-shifting is done based on the frequency ratio d by a pitch-shifting algorithm or by adjusting the control data of a control data sequence for a synthetic sound generation device based on the frequency ratio d or by adjusting the tuning of a synthetic sound generation device based on the frequency ratio d.

10. The method according to claim 1, characterized in that the target frequency is the frequency of a tinnitus sound of a person affected by tinnitus.

11. The method according to claim 1, characterized in that the pitch-shifted digital audio signal synthesized from a provided control data sequence is audible via an internal or external sound synthesis.

12. The method according to claim 1, characterized in that the pitch-shifted digital audio signal is audible via loudspeakers or headphones.

13. A device for performing the method according to the invention, characterized in that the device comprises:
a data processing device operably associated with;
a data storage device;
at least one input interface; and
at least one output interface.

14. The method according to claim 1 wherein the target frequency is tinnitus sound frequency.

15. The device according to claim 13, further including a device for sound synthesis operably associated with the data processing device.

16. The device according to claim 15, further including a loudspeaker operably associated with the device for sound synthesis.

17. The device according to claim 15, further including headphones operably associated with the device for sound synthesis.
